(19) United States
(12) Patent Application Publication
(10) Pub. No.: US 2011/0231898 A1
(43) Pub. Date: Sep. 22, 2011

(54) SYSTEMS AND METHODS FOR COLLABORATIVELY CREATING AN INTERNET MEDIATION POLICY

(76) Inventor: Tom C. Tovar, San Francisco, CA (US)

(21) Appl. No.: 12/986,982

(22) Filed: Jan. 7, 2011

Related U.S. Application Data
(63) Continuation-in-part of application No. 12/727,001, filed on Mar. 18, 2010.
(60) Provisional application No. 61/370,556, filed on Aug. 4, 2010.

(51) Int. Cl. H04L 29/06

(52) U.S. Cl. 726/1

(57) ABSTRACT

Methods and systems of collaboratively creating an Internet service mediation policy are disclosed. Various embodiments include an initiating Internet service user establishing a base mediation policy via a DNS server, one or more other Internet service users collaborating with the initiating Internet service user to modify the mediation policy, the collaborating including the other Internet service users submitting content for the mediation policy to the initiating Internet service user, and the initiating Internet service user publishing the mediation policy. In some embodiments, the initiating Internet service user determines what submitted Internet content may be included in the mediation policy.

### CROSS REFERENCE TO RELATED APPLICATIONS

This nonprovisional patent application is a continuation-in-part application that claims the priority benefit of U.S. patent application Ser. No. 12/727,001 filed on Mar. 18, 2010, titled “Internet Mediation,” and provisional U.S. Application Ser. No. 61/370,556, filed on Aug. 4, 2010, titled “Internet Mediation Applications,” the disclosures of which are hereby incorporated by reference in their entirety.

### BACKGROUND OF THE INVENTION

1. Field of the Invention

The present invention relates generally to providing Internet access. The present invention relates more particularly to systems and methods to collaboratively generate Internet mediation policies.

2. Background

Since the Internet was launched in 1995, the Internet has grown to become an instantly-searchable, vast repository of information on almost every topic imaginable. The Internet offers nearly limitless opportunity for creative users to create and distribute content, such as blogs, artwork, photography, creative writing, or scholarly research or reference articles. Additionally, the Internet serves as a platform for thousands of online games, in which users can become players in expansive, elaborate games that approximate an alternative reality. Although the Internet has vast positive value for users, it also offers an equal range of undesirable content. Such offensive content may be inadvertently accessed by a user following what appears to be a harmless link, or in response to what may seem to be an innocuous request. Therefore various means to mediate access to the Internet have arisen in order to allow users to access appropriate content.

### SUMMARY OF THE INVENTION

Various embodiments of the present invention provide systems and methods for collaboratively creating and modifying the mediation policy for Internet access delivered to the home or business of one or more end users. A mediation policy may describe the way in which Internet access is mediated or provisioned to users. As used herein, mediating Internet access may include any of blocking, filtering, constraining, enabling, redirecting, promoting, demoting, substituting, obscuring, limiting, interrupting, and restricting all or a portion of the Internet access.

Various methods and systems to control Internet access may be implemented through the use of a content mediation policy (“mediation policy”). Content mediation policies can be defined by an administrator or other initiating user. Content mediation policies can be defined to mediate Internet access for various users, including subscribers under an ISP (Internet service provider) account, an entire network such as a corporate or home local network, patrons of a facility such as a restaurant, coffee shop, Internet café, or other facility offering Internet access to users.

Embodiments of the present invention may take account of the particular browsing and content needs and desires of various users. Using the Internet, users may collaborate on mediation policies. Users may suggest content for inclusion in a mediation policy, create mediation policies of their own, form groups around a particular mediation policy, rate content, and share mediation policies. The mediation policy may then be adapted in real time, for example to restrict access to content that is newly discovered to be malicious, or in response to a malicious content report relating to a particular site or class of content. In this way, embodiments of the present invention may provide a mediation solution that is responsive to the desires of the end users.

Various embodiments of the present invention may be practiced on, and incorporate elements of an Internet service. As used herein, an Internet service may include a subscription service or software based service for administering Internet access to one or more users. An Internet service may include provisions for administering various access regimes, user accounts, sharing privileges, and other network attributes. An Internet service may be a network based service or a client based service executed by software resident on client computers.

One exemplary method of the present invention includes an initiating Internet service user establishing a base mediation policy and one or more other Internet service users collaborating with the initiating Internet service user to maintain the mediation policy. In some embodiments, the collaborating may include the other Internet service users submitting suggested content for the mediation policy to the initiating Internet service user. The initiating Internet service user may then determine what submitted Internet content may be included in the mediation policy. In some embodiments the initiating Internet service user modifies the Internet content submitted by other Internet service users, and then publishes the mediation policy for review and consideration by other users. In some embodiments, several Internet service users join together to create a group using a single set of mediation policies used by all users in a group. In various embodiments, the mediation policy may be specific to an app. For example, in one embodiment, an app may include a mediation policy defined for access to Internet content related to encouraging study habits.

Content mediation policies can be implemented at various points, such as at the DNS (Domain Name System) server level, local client level, or the ISP level. Embodiments of the present invention may be used by Internet Service Providers (ISPs). For purposes of this disclosure, the definition of “Internet service provider” will include any service or technology that provides a connection to the Internet. Examples of such technologies include, but are not limited to, traditional Internet service providers, telecommunications companies, cable operators, mobile operators, network operators and any other provider of wired or wireless access to Internet services. All such services are herein referred to as “ISPs.”

Embodiments of the present invention may be used to create a mediation policy to mediate a user request to resolve an Internet address at various communication layers, such as at the application layer. Embodiments of the present invention may be implemented at the network, domain, or DNS level, and at the local application level. Exemplary embodiments of the present invention may offer network-level mediation to users. Embodiments of the disclosed invention may be used to mediate Internet content by domain name.

Embodiments of the present invention may perform mediation policy updates in the network cloud, apply new mediation policies across all network resources, and apply mediation policies across some or all devices within a home or business network. Embodiments of the disclosed invention may be used with the full range of user devices capable of accessing and displaying content from the Internet. User devices may include desktop computers, PCs, laptops, notebooks, game consoles (e.g., an X-box), tables, smartphones and Internet enabled TVs. The present systems may also be accessed and controlled through mobile devices, such as a smartphone. A smartphone can be generally defined as a phone with computing capability. A smartphone may provide Internet access to a user. User devices may display content to the end user via a user interface, such as a web page, for example an html web page displayable in an Internet browser.

### BRIEF DESCRIPTION OF THE DRAWINGS

FIG. 1 is a block diagram of an exemplary system with exemplary method steps of use in accordance with embodiments of the present invention.

FIG. 2 is a block flow diagram of an exemplary method.

FIG. 3 is a block flow diagram of an exemplary method.

FIG. 4 is a block flow diagram of an exemplary method.

FIG. 5 is a block flow diagram of an exemplary method.

FIG. 6 is a block diagram of components of a system.

FIG. 7 is a block diagram of components of a system.

FIG. 8 is a block diagram of components of a system.

### DETAILED DESCRIPTION

One embodiment of the present invention is a method wherein a forum or platform is provided in which an initiating Internet service user, such as an administrator, creates an Internet service mediation policy to mediate access to Internet content by users of the Internet service. The Internet service may be Internet access such as provided by an ISP. In various embodiments, the initiating Internet service user may access the Internet service, create a mediation policy, and make changes to a mediation policy through a user account.

The initiating Internet service user may establish a base mediation policy, for example for implementation by a DNS (Domain Name System) server or resolver. One or more other Internet service users collaborating with the initiating Internet service user may modify the mediation policy. In some embodiments, the collaboration includes submitting Internet content for the mediation policy to the initiating Internet service user. The initiating Internet service user may publish a resulting mediation policy, for example via the DNS server. In some embodiments, the initiating Internet service user determines which of the submitted Internet content may be included in the mediation policy. The initiating Internet service user may also substitute the Internet content submitted by some or all of the other Internet service users prior to publishing a revised mediation policy, for example via the DNS server. In some embodiments, the initiating Internet service user may also modify the Internet content submitted by other Internet service users prior to publishing the mediation policy. In various embodiments, the mediation policy may be specific to a particular app. In some embodiments, the mediation polices are for use within a particular data network or Internet service.

Embodiments of the disclosed technology may have one or more functional components in data communication with each other over a data network, such as a DNS network, for example the Internet. Some embodiments of the disclosed invention may have one or more dynamic enforcement engines which may check user requests (such as requests to navigate to a website). The dynamic enforcement engine may check user requests to resolve Internet content in accordance with one or more defined mediation policies. The dynamic enforcement engine may allow or block requests to resolve Internet content requested by a user according to the mediation policy.

The mediation policy may store information relative to Internet content to which access will be denied and allowed. The mediation policy may include, for example, a list of prohibited websites, URLs, or domains. Mediation policies may define allowable access rules in accordance with manually specified lists or server configuration statements. In response to the results of checking a user request, the dynamic enforcement engine may provide policy instructions to an Internet server, for example the user's ISP's server which may be a DNS server, directing what content to resolve to the end user.

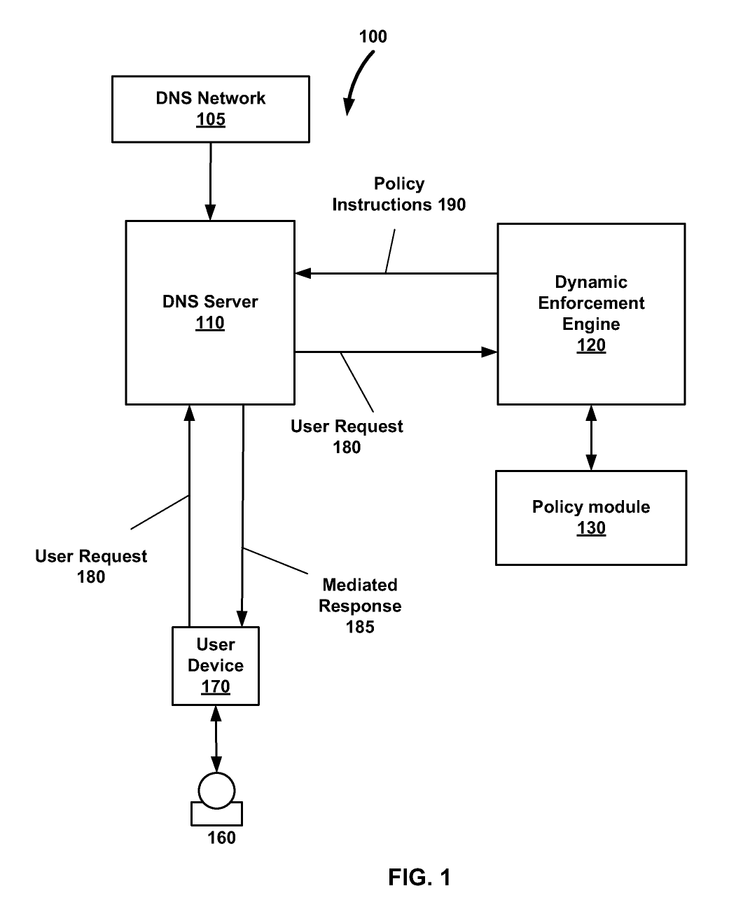

FIG. 1 illustrates system 100, an embodiment of the present invention. With reference to FIG. 1, in operation a user 160 may initiate a user request 180 through a user device 170, for example to resolve an Internet address on the DNS network 105. User 160 may be an administrator or other user of the Internet service. The user device 170 may be operated by the end user 160 to access the DNS network. In various embodiments, user devices 170 may include devices having network communication capabilities including but not limited to desktop personal computers, laptop personal computers, notebook personal computers, game consoles, tablets, smartphones, Internet enabled TVs, or mobile personal communication devices such as a smartphone or personal digital assistant (PDA).

In various embodiments, system 100 may have more than one user 160, without limit. More than one user 160 may be an administrator or have administrator privileges. A DNS server 110 may receive the user request 180 and transmit the user request 180 to a dynamic enforcement engine 120. The dynamic enforcement engine 120 may check the user request 180 based on information in a policy module 130, for example, a mediation policy. The dynamic enforcement engine 120 may check, for example, if the user request 180 includes a request to resolve an Internet address that is present in Internet content records used in the mediation policy. The mediation policy may be implemented by a policy module 130. The dynamic enforcement engine 120 may thereby mediate between user requests 180 and the DNS server 110.

The dynamic enforcement engine 120 may generate and transmit policy instructions 190 to the DNS server 110, thereby instructing the DNS server 110 which responsive action to take. The DNS server 110 may then provide a corresponding mediated response 185 to a user device 170. For example, in various embodiments, when the dynamic enforcement engine 120 determines that a user request 180 corresponds to an entry in the policy module 130, the dynamic enforcement engine 120 may provide the policy instructions 190 to the DNS server 110, resulting in various mediated responses 185 including, but not limited to, redirection of the user request 180 to an alternate address, direction to a hosted address presenting a warning message, direction to the end user's home page, direction to the ISP home page, allowing the original request, and any combination thereof. In various embodiments, the mediation policy may determine policy instructions 190 based on various factors, such as the identity of the requestor as indicated by an IP address, the account being used by the requestor, the time of the request, or other factors.

Policy module 130 may be accessible to dynamic enforcement engine 120 via the DNS network 105. Policy module 130 may be populated with domain names, URL's, or Internet addresses as provided from various sources such as the initiating user and other users. In some embodiments, at least one element of the mediation policy may be enforced directly by the DNS server 110. In some embodiments, policy module 130 may be maintained by or as a part of the DNS server 110 or another storage medium, locally, or hosted remotely. Dynamic enforcement engine 120 may be hosted on the DNS server 110, or another server co-located with the DNS server, or remotely, or installed locally on the user device 170.

The mediation policy may direct the dynamic enforcement engine 120 to check the user request 180 against a particular corresponding category of content within the mediation policy stored in the policy module 130. The mediation policy may include various mediation decision criteria for different user requests, based on a variety of factors. In some embodiments, the mediation policy may include manually specified lists and server configuration statements. The mediation policy may specify particular mediation behavior based on policy criteria. The mediated response 185 may take different forms. The criteria for blocking or redirection of a user request 180, for example, may be described by the mediation policy. For example, the mediated response 185 may include blocking or redirecting user requests 180.

Mediation policies, such as exemplary policy module 130 in FIG. 1, may be updated periodically or continuously. In various embodiments, mediation policies may be manually updated by an administrator. The mediation module may be updated automatically or on-demand. Updates may be suggested by other users, and transmitted to the administrator, who may have an access account to change the mediation policy. The administrator may consider the suggested changes and apply them as desired.

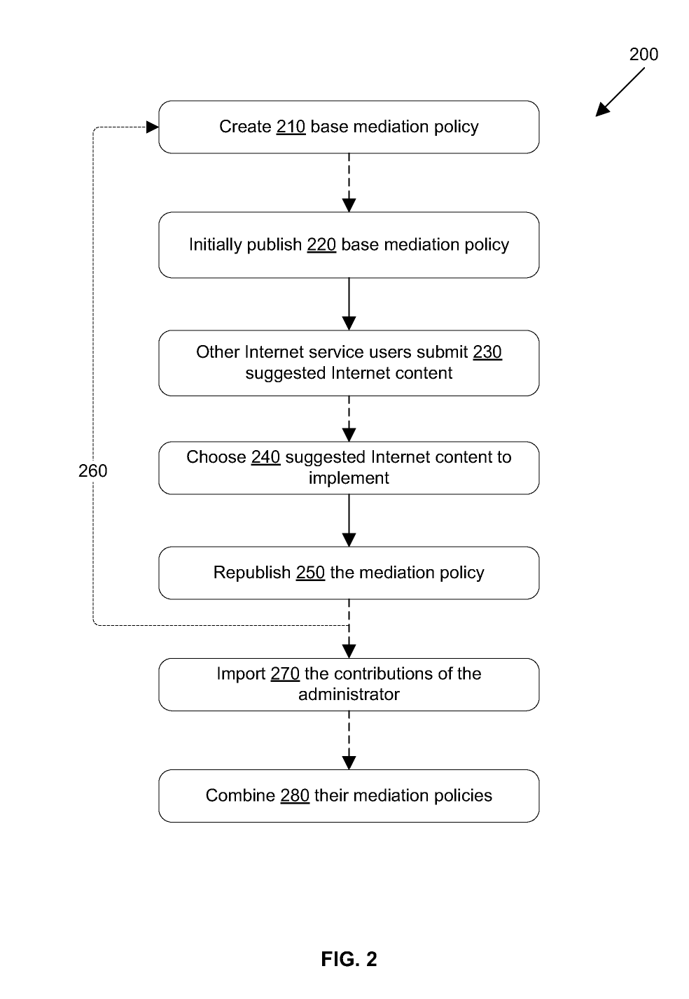

FIG. 2 illustrates an exemplary embodiment of a method of collaboratively creating an Internet service mediation policy, method 200. Method 200 includes the step of an initiating Internet service user, such as an administrator, creating 210 a base mediation policy. After the administrator creates 210 the base mediation policy, the administrator may optionally initially publish 220 the base mediation policy. The base mediation policy may thereby be reviewed and subscribed to by other users of the Internet service.

Then, one or more other Internet service users collaborating with the initiating Internet service user may suggest modifications the mediation policy. For example, the other Internet service users may submit 230 suggested Internet content for possible inclusion in the mediation policy to the administrator. For example, suggested Internet content may include websites and content that the users enjoy accessing, but which they are unable to access according to the base mediation policy. Suggested Internet content may be submitted to the administrator via an online submission board, blog, forum, or other resource that is accessible to the administrator and the other Internet users, or may be public. In some embodiments, the administrator may invite some other Internet users to make suggestions, or solicit suggestions from other users such as friends, family, or online members of other associations or groups. The administrator may moderate the contributions of other users, such as individuals or groups, invited by the administrator to contribute to the administrator's mediation policy. In various embodiments, the administrator may select a group of end users corresponding to parameters to collaborate on the establishment of the Internet content records used in the mediation policy.

Then, the administrator may optionally choose 240 from the suggestions Internet content to implement with the mediation policy. The administrator may republish 250 the mediation policy. This process can then proceed 260 iteratively. In some exemplary embodiments, other users of the Internet service may optionally import 270 for use in their own mediation policies the contributions of the administrator. The importation may be accomplished in a one time transaction, or an end user may subscribe to the administrator's mediation policy to receive continuing updates. In some embodiments, two or more administrators or other users may optionally combine 280 their mediation policies via this method of collaboration to create a single mediation policy that may be used by these and other administrators of the Internet service.

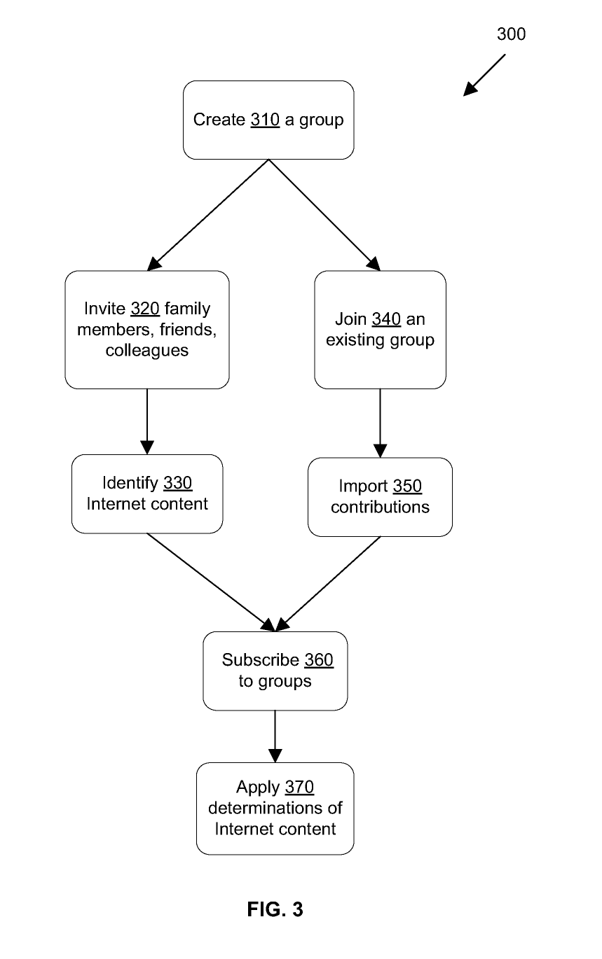

FIG. 3 illustrates a method 300 of collaboratively creating a mediation policy according to the present invention. In method 300, several Internet service users join together to create 310 a group using common mediation policies for Internet service users in that group. A user, such as an administrator, may create a new group or join an existing group. For example, an administrator may, before or after the administrator creates his own mediation policy, invite 310 the administrator's family members, friends, colleagues, or any group or combination of groups and individuals to join a group. The members may then identify 320 Internet content to be used by the administrator in creating the administrator's own mediation policy. These invitees may or may not be users of the Internet service but may nonetheless be allowed to contribute to the administrator's mediation policy, for example via the user interface of the Internet service or via mechanisms designed to receive input from authorized contributors such as APIs (application programming interfaces). In the alternative or in addition, the administrator may, before or after the administrator creates the administrator's own mediation policy, join 330 an existing group of users of the Internet service. Where there is an existing group that the administrator joins for purposes of creating a mediation policy, the administrator may choose to import 340 the contributions of other groups once or subscribe 350 to these groups to reduce the configuration burden of creating a mediation policy. The administrator may apply 360 the determinations of Internet content by a group to the administrator's own mediation policy.

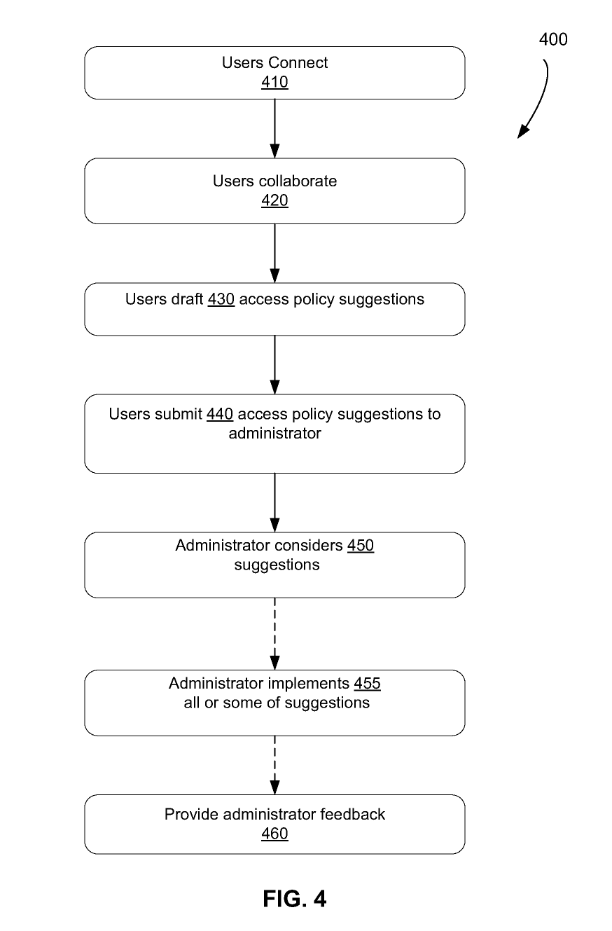

FIG. 4 illustrates method 400, wherein several Internet service users join together to create a group. In method 400, more than one user, such as between 2 and 100,000, for example 5 users, connect 410 with one another. Users may connect 410 through various existing relationships, such as online relationships formed around a common theme or interest. For example, a gaming community, a hobby community, parents of young children, retirees, college students, people with related political sensibilities, bloggers, video bloggers, or other online communities. Users then collaborate 420 with one another regarding their preferences with respect to a mediation policy to allow or block certain content. The users then draft 430 access policy suggestions based on their preferences, and submit 440 their suggestions to the administrator.

In some embodiments, a user may post a draft mediation policy for review and consideration by users, group members, and in some embodiments, others. For example, a mediation policy may be posted on a website allowing comments, suggestions, and voting. Users may be required to enter access credentials to post comments and to vote. After a predetermined period of time, the votes may be tallied and some subsets of the suggestions that reach some voting threshold may be accepted and included in the access policy suggestions. In some embodiments, an administrator may moderate this process of comments, suggestions, and voting.

In some embodiments, Internet service users may submit particular Internet comments to a group or to a forum for consideration. Users may rate the Internet content submitted by other Internet users. In various embodiments, the members within a group modify ratings of submitted Internet content based on hierarchal standings. The administrator then considers 450 the access policy suggestions and determines which of the suggestions to implement, if any. The administrator may optionally implement 455 any or all of the access policy suggestions. Optionally, the administrator can provide 460 administrator feedback to the users. In various embodiments, administrator feedback may include suggested changes to the user suggestions, confirmation of the implementation of any or all access policy suggestions, or notice of denial of the access policy suggestions, including, optionally, reasons and bases for any determinations. One or more users may be a member of more than one group having different mediation policies.

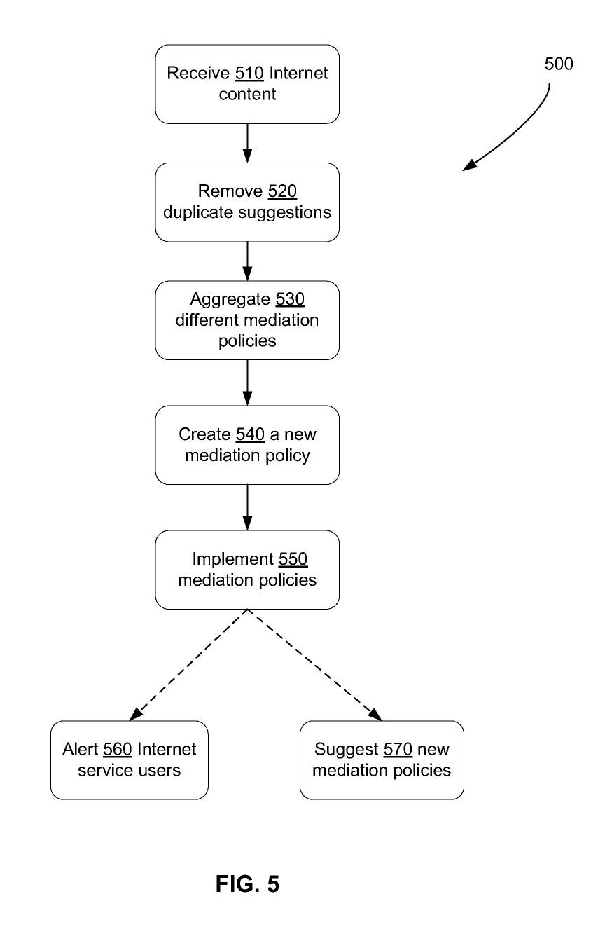

In some embodiments, the process of collaboratively suggesting and implementing mediation policies for a group may proceed automatically without intervention by an administrator. FIG. 5 illustrates method 500, showing a method by which users collaboratively create a mediation policy without administrator intervention. In method 500, an Internet service, such as an ISP or organization web server, may receive 510 Internet content or suggested mediation policies from Internet service users for suggested incorporation into a mediation policy. In various embodiments, the Internet service may automatically remove 520 duplicate suggestions provided by users. The Internet service may then aggregate 530 different mediation policies incorporating Internet content provided by Internet service users. The Internet service may then automatically create 540 a new mediation policy or policies using some or all of the different mediation policies. The Internet service may implement 550 one or more of the mediation policies for use by the group. In various embodiments, the Internet service may optionally alert 560 Internet service users to related groups that have generated useful Internet content policy guidelines. In other embodiments, the Internet Service may also optionally suggest 570 new mediation policies incorporating Internet content provided from Internet service users, and in some embodiments, Internet content generated by the Internet service itself.

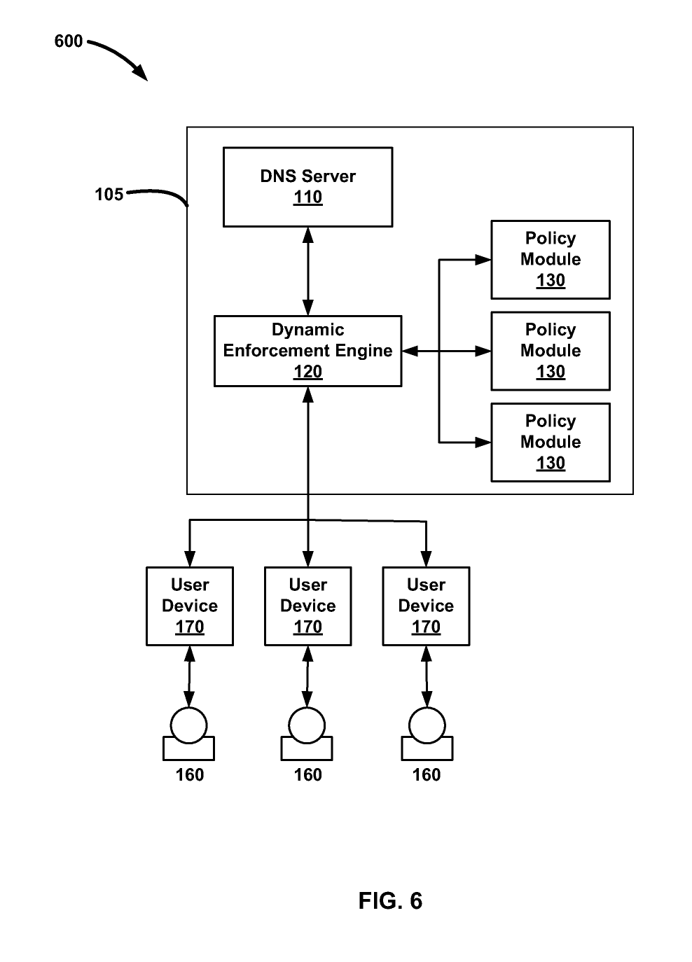

FIG. 6 illustrates an embodiment of a system 600 for supplying Internet service via a DNS network 105 according to the present invention. A DNS server 110 operates in conjunction with a dynamic enforcement engine 120. The dynamic enforcement engine 120 may communicate with one or more policy modules 130 to provide policy instructions to the DNS server 110. System 600 may have end users 160, including consumers and Internet service subscribers, and users accessing Internet services provided by the operator of the DNS server 110, such as an ISP. End users 160 may use user devices 170 to access the Internet service. In various embodiments, the DNS server 110 may receive and forward user requests for service of domain addresses to the dynamic enforcement engine 120. Domain addresses that host offensive content may be catalogued in a mediation policy accessible to the dynamic enforcement engine 120.

FIG. 6 illustrates an exemplary Internet service system 600, with a DNS server 110, that may be utilized to support the above described systems and methods. DNS server 110 operates in conjunction with a dynamic enforcement engine 120. The dynamic enforcement engine 120 may operate in conjunction with one or more policy modules 130 to establish any applicable polices at the DNS level. The dynamic enforcement engine 120 applies content rules to received user queries, and determines the content that is delivered by DNS network 105 through various user devices 170 to the users 160.

The dynamic enforcement engine 120 may generate its content rules based on instructions received from one or more policy modules 130. Each policy module 130 may be constructed to provide various types and levels of services to the DNS network 105. In various embodiments, the policy module 130 may be configured to handle queries directed to subjects including, but not limited to, malicious domain redirection, user access redirection, non-existent domain redirection, and data collection or analysis.

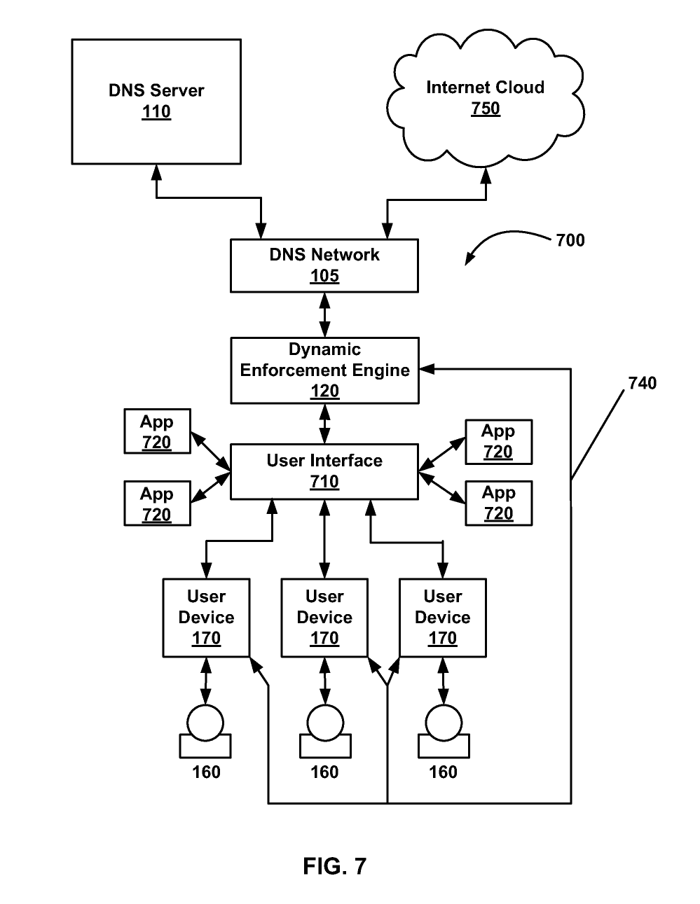

FIG. 7 shows a schematic layout of an exemplary system 700 for implementing direct and variable user control. FIG. 7 illustrates that the system 700 may operate installed on a DNS server 110, or with a cloud 750 based installation.

The system 700 utilizes a user interface 710. The user interface 710 may be implemented in many embodiments. One specific implementation of the user interface 710 is as a web page. In various embodiments, a user may access the Internet service, create a mediation policy, and make changes to a mediation policy using the user interface 710. In some embodiments of the present invention, a user, including an initiating user, may access user interface 710 on a user device, and log in to his or her user account. In some embodiments, the user logs in to his or her user account by supplying credentials, such as a user name and a password. In various exemplary embodiments, the user account may be an Internet service account, for example as established with the user's ISP. In some embodiments of system 700, the system 700 receives a valid log-in request from a user to log-in to a user account associated with the user, for example a user account to provide Internet service over the network communication system such as may be provided by an ISP. In some embodiments, a valid log-in request comprises valid credentials supplied by the user, such as a valid user name and password. In response, system 700 may log the user in to the system 700 and provides Internet access over the network communication system to the user under the user's account. In some embodiments, once logged in to his user account, the user may make, implement, create, delete, or change a mediation policy, or change the applicability or other attributes of the mediation policy.

The user interface 710 may be accessed by one or more user devices 170 operated by the users 160. The user interface 710 may be accessed through a gateway user device 170 available to the users 160. Suitable user devices 170 include but are not limited to desktops, PCs, laptops, notebooks, gaming devices, iPods, iPhones, automobile computer systems, and Internet enabled TVs. The system 700 may be accessed and controlled through remote control user devices 170, such as a Smartphone. A Smartphone can be defined as a phone with computing capability. A Smartphone can provide the user 160 with Internet access.

The user interface 710 provides a mechanism for one or more authorized users 160 to establish content policy for the Internet service. The user interface 710 operates between the user devices 170 present in the system 700 and the DNS network 105. Instructions resident on the user interface 710 therefore operate on the Internet service, by controlling at least a portion of DNS resolutions via a dynamic enforcement engine 120, before the service reaches the displays of the user devices 170.

The user interface 710 provides the users 160 with access to one or more policy apps 720. The user interface 710 may provide access to a selection list to at least one authorized user 160. The authorized user 160 uses the selection list or some other menu mechanism to select those policy apps 720 that the user 160 chooses to apply to the system 700. The authorized user 160 may select any number of the available policy apps 720 for use on the system 700 at any given time. In implementations utilizing Smartphones as the user device 170, the policy apps 720 are downloaded to the device 170. The device 170 then serves as the user interface 710 to communicate directly with the dynamic enforcement engine 120.

The policy apps 720 may prohibit access to specific sites. The policy apps 720 may also limit the time of day when users or selected users 160 may access certain sites. The policy apps 720 may also manage and analyze duration of access to various sites. It is important to note that the policy apps 720 do not simply provide blocking mechanisms by masking or enabling network controls, but rather mediate an Internet service received by the user. The policy apps 720 may provide notifications or alerts to one or more users 160 when sites are accessed. The policy apps 720 may also provide notification of frequency and duration of access of designated sites. The policy apps 720 may also be used to observe, substitute, enable, redirect users, to reward behavior desired from the users by a system administrator, etc. The policy apps 720 may redirect users from a non-favored site to another site. The policy apps 720 may also collect and transmit data characteristic of Internet use.

Mediation policies supplied by the policy apps 720 may apply to all users 160 of the system 700, or the mediation policies may be specific to individual users or groups of users 160. The policy apps 720 may be discrete, single purpose apps.

The policy apps 720 provide the users 170 with a mechanism to take various actions relative to their Internet service feed. The policy apps 720 also allow the users 170 to establish a dynamic enforcement engine 120 that includes a user database. The dynamic enforcement engine 120 is used to enforce rules associated with each policy app associated with individual users, not simply block various inappropriate sites from the Internet feed. Rather, the dynamic enforcement engine 120, controlled by the user interface 710 through user device(s) 170, is used to manage all aspects of the Internet experience for the users 160. In sum, the policy apps 720 may be used to configure the dynamic enforcement engine 120 to provide the users 160 with a mechanism to personalize the Internet experience. The policy apps 720 may be configured in combinations, and may each be separately configured.

The database in the dynamic enforcement engine 120 may be used to record and to notify users 160 of various data relative to Internet access. The data collected from and provided to the users 160 may include records of access of specific sites, time spent on specific sites, time of day of access, data specific to individual users, etc.

It should also be noted that following an initial setup through the user interface 710 of the dynamic enforcement engine 120, a direct access 740 enforcement loop may be established between the dynamic enforcement engine 120 and the user devices 170. Subsequent accessing of the DNS network 105 utilizing the direct access 740 decreases response time in the system 700, thereby further enhancing the Internet experience of the users 160. Configurations of policy apps 720 that are selected by one or more users 160 designated as system administrators may remain in the user database of the dynamic enforcement engine 120 until such time as it can be modified by the system administrators. The system administrators may define multiple policy configurations, with a combination of policy apps 720, applicable to one or more users 160 of the system 700. Each policy app 720 may be separately configurable as well. Policy configurations may vary based upon designated times, conditional triggers, or specific requests from the users 160 with administrative authority.

Two discrete data flow paths may be established for the system 700. A first data path establishes a set of mediation policies for the system 700. The first data path flows from at least one user device 170 through the user interface 710, to the dynamic enforcement engine 120. A second data path 740 may be utilized following the establishment of a set of policies for the system 700. The second data path 740 flows directly between the user device(s) 170 and the dynamic enforcement engine 120. Multiple sets of mediation policies may be established and saved within the system 700 and implemented selectively by the users 160.

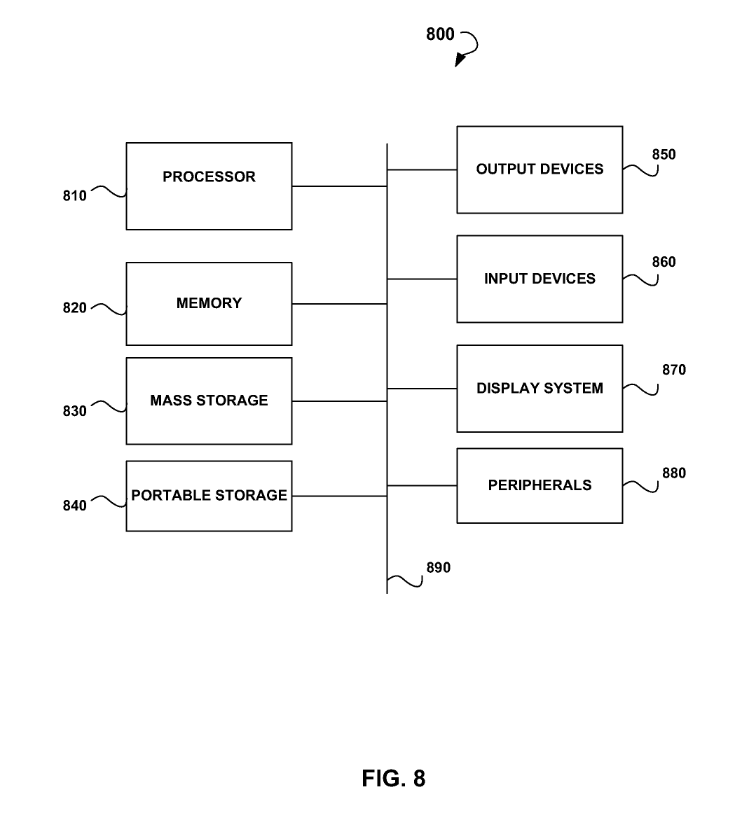

FIG. 8 illustrates an exemplary computing system 800 that may be used to implement an embodiment of the present invention. System 800 of FIG. 8 may be implemented in the context of user devices 170, DNS server 110, Internet cloud 950 and the like. The computing system 800 of FIG. 8 includes one or more processors 810 and memory 820. Main memory 820 stores, in part, instructions and data for execution by processor 810. Main memory 820 may store the executable code when the system 800 is in operation. The system 800 of FIG. 8 may further include a mass storage device 830, portable storage medium drive(s) 840, output devices 850, user input devices 860, a graphics display 840, and other peripheral devices 880.

The components shown in FIG. 8 are depicted as being connected via a single bus 890. The components may be connected through one or more data transport means. Processor unit 810 and main memory 820 may be connected via a local microprocessor bus, and the mass storage device 830, peripheral device(s) 880, portable storage device 840, and display system 870 may be connected via one or more input/output (I/O) buses.

Mass storage device 830, which may be implemented with a magnetic disk drive or an optical disk drive, is a non-volatile storage device for storing data and instructions for use by processor unit 810. Mass storage device 830 may store the system software for implementing embodiments of the present invention for purposes of loading that software into main memory 810.

Portable storage device 840 operates in conjunction with a portable non-volatile storage medium, such as a floppy disk, compact disk or Digital video disc, to input and output data and code to and from the computer system 800 of FIG. 8. The system software for implementing embodiments of the present invention may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, or a pointing device, such as a mouse, a trackball, stylus, or cursor direction keys. Additionally, the system 800 as shown in FIG. 8 includes output devices 850. Suitable output devices include speakers, printers, network interfaces, and monitors.

Display system 870 may include a liquid crystal display (LCD) or other suitable display device. Display system 870 receives textual and graphical information, and processes the information for output to the display device.

Peripherals 880 may include any type of computer support device to add additional functionality to the computer system. Peripheral device(s) 880 may include a modem or a router.

The components contained in the computer system 800 of FIG. 8 are those typically found in computer systems that may be suitable for use with embodiments of the present invention and are intended to represent a broad category of such computer components that are well known in the art. Thus, the computer system 800 of FIG. 8 may be a personal computer, hand held computing device, telephone, mobile computing device, workstation, server, minicomputer, mainframe computer, or any other computing device. The computer may also include different bus configurations, networked platforms, multi-processor platforms, etc. Various operating systems may be used including UNIX, Linux, Windows, Macintosh OS, Palm OS, and other suitable operating systems.

Some of the above-described functions may comprise instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

Any hardware platform suitable for performing the processing described herein is suitable for use with the invention. The terms “computer-readable storage medium” and “computer-readable storage media” as used herein refer to any medium or media that participate in providing instructions to a CPU for execution. Such media may take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media may also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

The systems and methods described above may typically be resident in an Internet service or a DNS network. For instance, although this description describes the technology in the context of a DNS server, it will be appreciated by those skilled in the art that an Internet service provider may be utilized with this invention instead or in conjunction with a DNS server. Functionalities and method steps that are performed by a DNS server may be performed by an Internet service provider. Furthermore, one skilled in the art will appreciate that the term “Internet content” comprises one or more web sites, domains, web pages, web addresses, one or more hyperlinks, URLs, any text, pictures, and/or media (such as video, audio, and any combination of audio and video) provided or displayed on a web page, and any combination thereof.

The systems and methods described may also be implemented in plug-in utilities, gateway devices, cable modems, proxy servers, set top boxes, and network interface devices. Further, as will be appreciated by those of ordinary skill in the art, the embodiments presented herein may be implemented on any form of Internet service, including, but not limited to, Broadband wireless access, Cable Internet, Dial-up, ISDN, Modem, DSL, FTTH, Wi-Fi, DSL, Ethernet technologies, and SHDSL services, as well as others.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

While the present invention has been described in connection with a series of preferred embodiment, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as can be included within the spirit and scope of the invention as defined by the present appended claims and otherwise appreciated by one of ordinary skill in the art.

What is claimed is:

1. A method of creating a mediation policy for an Internet service, the method comprising:
providing a platform for an initiating Internet service user to create a mediation policy;
allowing the initiating Internet service user to invite one or more Internet service users to collaborate to establish criteria for the mediation policy;
providing a mechanism for the one or more Internet service users to collaborate to modify the mediation policy, the one or more Internet service users submitting Internet content for the mediation policy; and
updating the mediation policy with the submitted Internet content of the one or more Internet Service users.

2. The method of claim 1, wherein the method applies the mediation policy to the Internet service of at least one of the one or more Internet service users upon acceptance of the mediation policy by the one or more Internet users.

3. The method of claim 1, wherein updates to the mediation policy are automatically applied to the one or more Internet service users.

4. The method of claim 1, wherein the initiating Internet service user determines which of the submitted Internet content is to be included in the mediation policy.

5. The method of claim 1, wherein the initiating Internet service user determines which of the submitted Internet content is to be included in the mediation policy and wherein the initiating Internet service user substitutes at least some of the Internet content submitted by other Internet service users into the mediation policy.

6. The method of claim 1, wherein the initiating Internet service user determines which of the submitted Internet content is to be included in the mediation policy and wherein the initiating Internet service user modifies at least some of the Internet content submitted by other Internet service users.

7. The method of claim 1, wherein establishing the criteria for a mediation policy includes establishing a mediation policy specific to an app.

8. The method of claim 1, wherein establishing the mediation policy includes the initiating user publishing a mediation policy for use within the Internet service.

9. The method of claim 1, wherein publishing the mediation policy includes publishing the mediation policy for use by users of the Internet service.

10. The method of claim 1, wherein the initiating Internet user is an administrator.

11. The method of claim 1, further comprising users of the Internet service receiving a suggestion of additional Internet content from the Internet service.

12. The method of claim 1, further comprising providing a common mediation policy to at least two users of the Internet service.

13. The method of claim 1, further comprising providing a common mediation policy to at least two users of the Internet service, and wherein at least one of the users uses mediation policies from one or more other groups of Internet users.

14. The method of claim 1, further comprising providing a common mediation policy to at least two users of the Internet service joined together in a group around a specific app to create a group using a common mediation policy for the Internet service users in the group.

15. The method of claim 1, further comprising providing a common mediation policy to at least two users of the Internet service joined together in a group around a specific app, wherein the group collaboratively submits Internet content to the initiating Internet service user.

16. The method of claim 1, further comprising providing a common mediation policy to at least two users of the Internet service joined together in a group around a specific app to create a group using a common mediation policy, the Internet service processing and updating mediation policies incorporating Internet content from Internet service users and Internet content generated by the Internet service for use by the group.

17. The method of claim 1, further comprising providing a common mediation policy to at least two users of the Internet service joined together in a group around a specific app, and further comprising the Internet service aggregating and updating mediation policies incorporating Internet content from Internet service users and Internet content generated by the Internet service for use by the group.

18. The method of claim 1, further comprising providing a common mediation policy to at least two users of the Internet service joined together around a specific app to create a group using a common mediation policy, and further comprising the Internet service suggesting new mediation policies incorporating Internet content from Internet service users and Internet content generated by the Internet service and the Internet service publishing mediation policies for use by the group.

19. The method of claim 1, further comprising providing a common mediation policy to at least two users of the Internet service joined together around a specific app to create a group using a common mediation policy, and further comprising the Internet service removing duplicate mediation policies incorporating Internet content from Internet service users and Internet content generated by the Internet service and the Internet service updating mediation policies for use by the group.

20. The method of claim 1, wherein the initiating Internet service user establishes a mediation policy having at least one element resident on a DNS server.

21. The method of claim 1, wherein a DNS server enforces at least one element of the mediation policy.

22. The method of claim 1, further comprising automatically updating the mediation policy via the Internet service.

23. The method of claim 1, wherein the initiating Internet service user manually updates the mediation policy.

24. The method of claim 1, further comprising providing a common mediation policy to at least two users of the Internet service joined together to create a group using a common mediation policy, and further comprising alerting Internet service users via the Internet service to related groups using policies containing related Internet content.

25. The method of claim 1, further comprising allowing an Internet user other than the initiating Internet user to republish certain elements of an existing mediation policy.

26. The method of claim 1, further comprising allowing Internet service users to rate the Internet content submitted by other Internet users.

27. The method of claim 1, further comprising automatically updating the mediation policy via the Internet service and further comprising rating via the Internet service the Internet content submitted by Internet service users.

28. The method of claim 1, further comprising allowing the initiating Internet service user to manually update the mediation policy and further comprising rating via the Internet service the Internet content submitted by Internet service users.

29. The method of claim 1, further comprising automatically updating the mediation policy via the Internet service and further comprising identifying via the Internet service a group of Internet service users based on a rating of Internet content.

30. The method of claim 1, further comprising allowing the initiating Internet service user to manually update the mediation policy and further comprising identifying via the Internet service a group of Internet service users based on a rating of Internet content.

31. The method of claim 1, further comprising allowing the initiating Internet service user to manually update the mediation policy, and wherein several Internet service users within a group modify ratings of submitted Internet content based on hierarchal standings.

32. The method of claim 1, further comprising automatically updating the mediation policy via the Internet service, and wherein several Internet service users within a group modify ratings of submitted Internet content based on hierarchal standings.

33. A method of creating a mediation policy for an Internet service, the method comprising:
providing a platform for an initiating Internet service user to create a mediation policy via a DNS server;
allowing the initiating Internet service user to invite one or more Internet service users to collaborate to establish criteria for the mediation policy;
providing a mechanism for the one or more Internet service users to collaborate to establish and modify the mediation policy, the one or more Internet service users submitting Internet content for the mediation policy; and
updating the mediation policy via the DNS server.

34. The method of claim 33, wherein the method applies the mediation policy to the Internet service of at least one of the one or more Internet service users upon acceptance of the mediation policy by the one or more Internet users.

35. The method of claim 33, wherein the method automatically applies updates to the mediation policy to at least one of the one or more Internet service users.

36. The method of claim 33, wherein the initiating Internet service user determines which of the submitted Internet content is to be included in the mediation policy.

37. The method of claim 33, wherein the initiating Internet service user determines which of the submitted Internet content is to be included in the mediation policy and wherein the initiating Internet service user substitutes at least some of the Internet content submitted by other Internet service users into the mediation policy via the DNS server.

38. The method of claim 33, wherein the initiating Internet service user determines which of the submitted Internet content is to be included in the mediation policy and wherein the initiating Internet service user modifies at least some of the Internet content submitted by other Internet service users.

39. The method of claim 33, wherein establishing criteria for a mediation policy includes establishing a mediation policy specific to an app.

40. The method of claim 33, wherein establishing criteria for a mediation policy includes establishing a mediation policy for use within the Internet service.

41. The method of claim 33, wherein the initiating Internet user is an administrator.

42. The method of claim 33, wherein the mediation policy is made available for use by users of the Internet service via the DNS server.

43. The method of claim 33, further comprising the Internet service generating suggestions for additional Internet content for the mediation policy.

44. The method of claim 33, further comprising providing a common mediation policy to at least two users of the Internet service joined together to create a group using a common mediation policy.

45. The method of claim 33, further comprising providing a common mediation policy to at least two users of the Internet service joined together to create a group using a common mediation policy, and users in the group using mediation policies from one or more other groups.

46. The method of claim 33, further comprising providing a common mediation policy to at least two users of the Internet service joined together around a specific app to create a group using a common mediation policy.

47. The method of claim 33, further comprising providing a common mediation policy to at least two users of the Internet service joined together around a specific app to create a group using a common mediation policy, and wherein the group collaboratively submits Internet content to the initiating Internet service user.

48. The method of claim 33, further comprising providing a common mediation policy to at least two users of the Internet service joined together around a specific app to create a group using a common mediation policy and updating via the DNS server mediation policies incorporating Internet content from Internet service users and Internet content generated by the Internet service for use by the group.

49. The method of claim 33, further comprising providing a common mediation policy to at least two users of the Internet service joined together around a specific app to create a group using a common mediation policy, and further comprising the Internet service aggregating and updating mediation via the DNS server policies incorporating Internet content from Internet service users and Internet content generated by the Internet service for use by the group.

50. The method of claim 33, further comprising providing a common mediation policy to at least two users of the Internet service joined together around a specific app to create a group using a common mediation policy and further comprising the Internet service suggesting new mediation policies incorporating Internet content from Internet service users and Internet content generated by the Internet service and the Internet service updating mediation policies for use by the group via the DNS server.

51. The method of claim 33, further comprising providing a common mediation policy to at least two users of the Internet service joined together around a specific app to create a group using a common mediation policy for the Internet service users in the group and further comprising the Internet service removing duplicate mediation policies incorporating Internet content from Internet service users and Internet content generated by the Internet service and the Internet service updating mediation policies for use by the group via the DNS server.

52. The method of claim 33, wherein at least one element of the mediation policy is resident on a DNS server.

53. The method of claim 33, wherein at least one element of the mediation policy is enforced by the DNS server.

54. The method of claim 33, further comprising the Internet service automatically updating the mediation policy.

55. The method of claim 33, further comprising the initiating Internet service user manually updating the mediation policy.

56. The method of claim 33, further comprising providing a common mediation policy to at least two users of the Internet service joined together to create a group using a common mediation policy for the Internet service users in the group and further comprising the Internet service alerting Internet service users to related groups containing related Internet content.

57. The method of claim 33, further comprising a user other than the initiating user republishing certain elements of an existing mediation policy via the DNS server.

58. The method of claim 33, further comprising Internet service users rating the Internet content submitted by other Internet users.

59. The method of claim 33, further comprising the Internet service automatically updating the mediation policy and further comprising the Internet service rating the Internet content submitted by other Internet service users.

60. The method of claim 33, further comprising the initiating Internet service user manually updating the mediation policy and further comprising the Internet service rating the Internet content submitted by other Internet service users.

61. The method of claim 33, further comprising automatically updating the mediation policy via the Internet service and further comprising the Internet service creating a group of Internet service users based on a rating of Internet content.

62. The method of claim 33, further comprising allowing the initiating Internet service user to manually update the mediation policy and further comprising creating via the Internet service a group of Internet service users based on a rating of Internet content.

63. The method of claim 33, further comprising allowing the initiating Internet service user to manually update the mediation policy, and further comprising several Internet service users joining together to create a group using a common mediation policy for the Internet service users in the group, and further comprising the several Internet service users within the group modifying ratings of submitted Internet content based on hierarchal standings.

64. The method of claim 33, further comprising allowing the Internet service to automatically update the mediation policy, and further comprising several Internet service users joining together to create a group using a common mediation policy for the Internet service users in the group, and further comprising the several Internet service users within the group modifying ratings of submitted Internet content based on hierarchal standings.

65. A non-transient computer-readable medium including processor-executable instructions that, when executed by one or more processors, cause the one or more processors to execute a method of mediating access to the Internet by a user, the method comprising:
providing a platform for an initiating Internet service user to create a mediation policy via a DNS server;
allowing the initiating Internet service user to invite one or more Internet service users to collaborate to establish criteria for the mediation policy;
providing a mechanism for the one or more Internet service users to collaborate to establish and modify the mediation policy, the one or more Internet service users submitting Internet content for the mediation policy; and
updating the mediation policy via the DNS server.

66. The medium according to claim 65, wherein the mediation policy is applied to one or more Internet service users for use with their Internet service upon acceptance of the mediation policy by the one or more Internet users.

67. The medium according to claim 65, wherein updates to the mediation policy are automatically applied to Internet service users.

68. The medium according to claim 65, wherein the initiating Internet service user determines which of the submitted Internet content is to be included in the mediation policy.

69. The medium according to claim 65, wherein the initiating Internet service user determines which of the submitted Internet content is to be included in the mediation policy and wherein the initiating Internet service user substitutes at least some of the Internet content submitted by other Internet service users prior to publishing the mediation policy via the DNS server.

70. The medium according to claim 65, wherein the initiating Internet service user determines which of the submitted Internet content is to be included in the mediation policy and wherein the initiating Internet service user modifies at least some of the Internet content submitted by other Internet service users prior to publishing the mediation policy via the DNS server.

71. The medium according to claim 65, wherein establishing criteria for a mediation policy includes establishing a mediation policy specific to an app.

72. The medium according to claim 65, wherein establishing criteria for a mediation policy includes establishing a mediation policy for use within the Internet service.

73. The medium according to claim 65, wherein the initiating Internet user is an administrator.

74. The medium according to claim 65, wherein publishing the mediation policy includes publishing the mediation policy for use by users of the Internet service via the DNS server.

75. The medium according to claim 65, further comprising users of the Internet service receiving a suggestion of additional Internet content from the Internet service.

76. The medium according to claim 65, further comprising providing a common mediation policy to at least two users of the Internet service joined together to create a group using a common mediation policy for the Internet service users in the group.

77. The medium according to claim 65, further comprising providing a common mediation policy to at least two users of the Internet service joined together to create a group using a common mediation policy for the Internet service users in the group, and user in the group using mediation policies from one or more other groups.

78. The medium according to claim 65, further comprising providing a common mediation policy to at least two users of the Internet service joined together around a specific app to create a group using a common mediation policy for the Internet service users in the group.

79. The medium according to claim 65, further comprising providing a common mediation policy to at least two users of the Internet service joined together around a specific app to create a group using a common mediation policy for the Internet service users in the group and wherein the other Internet service users submitting Internet content for the mediation policy to the initiating Internet service user comprises the group collaboratively submitting Internet content to the initiating Internet service user for mediation.

80. The medium according to claim 65, further comprising providing a common mediation policy to at least two users of the Internet service joined together around a specific app to create a group using a common mediation policy for the Internet service users in the group and further comprising the Internet service processing and publishing mediation policies incorporating Internet content from Internet service users and Internet content generated by the Internet service for use by the group via the DNS server.

81. The medium according to claim 65, further comprising providing a common mediation policy to at least two users of the Internet service joined together around a specific app to create a group using a common mediation policy for the Internet service users in the group and further comprising the Internet service aggregating and publishing mediation policies incorporating Internet content from Internet service users and Internet content generated by the Internet service for use by the group via the DNS server.

82. The medium according to claim 65, further comprising providing a common mediation policy to at least two users of the Internet service joined together around a specific app to create a group using a common mediation policy for the Internet service users in the group and further comprising the Internet service suggesting new mediation policies incorporating Internet content from Internet service users and Internet content generated by the Internet service and the Internet service publishing mediation policies for use by the group via the DNS server.

83. The medium according to claim 65, further comprising providing a common mediation policy to at least two users of the Internet service joined together around a specific app to create a group using a common mediation policy for the Internet service users in the group and further comprising the Internet service removing duplicate mediation policies incorporating Internet content from Internet service users and Internet content generated by the Internet service and the Internet service publishing mediation policies for use by the group via the DNS server.

84. The medium according to claim 65, wherein an initiating Internet service user establishing a mediation policy comprises an initiating Internet service user establishing a mediation policy having at least one element resident on a DNS server.

85. The medium according to claim 65, further comprising a DNS server enforcing at least one element of the mediation policy.

86. The medium according to claim 65, further comprising the Internet service automatically updating the mediation policy.

87. The medium according to claim 65, further comprising the initiating Internet service user manually updating the mediation policy.

88. The medium according to claim 65, wherein the method provides a common mediation policy to at least two users of the Internet service joined together to create a group using a common mediation policy for the Internet service users in the group and further comprising the Internet service alerting Internet service users to related groups containing related Internet content.

89. The medium according to claim 65, further comprising a user other than the initiating user republishing certain elements of an existing mediation policy via the DNS server.

90. The medium according to claim 65, further comprising Internet service users rating the Internet content submitted by other Internet users.

91. The medium according to claim 65, further comprising the Internet service automatically updating the mediation policy and further comprising the Internet service rating the Internet content submitted by other Internet service users.

92. The medium according to claim 65, further comprising the initiating Internet service user manually updating the mediation policy and further comprising the Internet service rating the Internet content submitted by other Internet service users.

93. The medium according to claim 65, further comprising the Internet service automatically updating the mediation policy and further comprising the Internet service creating a group of Internet service users based on a rating of Internet content.

94. The medium according to claim 65, further comprising the initiating Internet service user manually updating the mediation policy and further comprising the Internet service creating a group of Internet service users based on a rating of Internet content.

95. The medium according to claim 65, further comprising the initiating Internet service user manually updating the mediation policy, and further comprising several Internet service users joining together to create a group using a common mediation policy for the Internet service users in the group, and further comprising the several Internet service users within the group modifying ratings of submitted Internet content based on hierarchal standings.

96. The medium according to claim 61, further comprising the Internet service automatically updating the mediation policy, and further comprising several Internet service users joining together to create a group using a common mediation policy for the Internet service users in the group, and further comprising the several Internet service users within the group modifying ratings of submitted Internet content based on hierarchal standings.

97. A system for creating a mediation policy for users of an Internet service, comprising:
a Domain Name System (DNS) server coupled to a TCP/IP network;
an initiating user account associated with an initiating user, the initiating user account configured to provide the initiating user with access to the Internet service through the DNS server;
a policy module configured to store a base mediation policy associated with the initiating user account, the policy module being coupled to the DNS server; and
a dynamic enforcement engine in communication with the DNS server and configured to apply the mediation policy to direct the DNS server to mediate Internet access to the users.

98. The system of claim 97, wherein the initiating user account is configured to receive submissions of Internet content from the users and is further configured to allow the initiating user to direct which of the submitted Internet content is to be included in a revised mediation policy.

99. The system of claim 97, wherein the initiating user account is configured to receive submissions of Internet content from the users and is further configured to allow the initiating user to direct which of the submitted Internet content is to be included in a revised mediation policy and wherein the DNS server is configured to receive an instruction via the initiating user account to publish the revised mediation policy.

100. The system of claim 97, wherein the base mediation policy is specific to an app.

101. The system of claim 97, wherein the base mediation policy is for use within the Internet service.

102. The system of claim 97, wherein the initiating user is an administrator.

103. The system of claim 97, wherein the Internet service is configured to suggest to the users additional Internet content for inclusion in a mediation policy.

104. The system of claim 97, wherein the policy module is configured to receive and store a mediation policy provided by several users who are members of a group.

105. The system of claim 97, wherein the policy module is configured to receive and store a mediation policy provided by several users who are members of a group and wherein the initiating user account is configured to receive Internet content collaboratively submitted by the members of the group for inclusion in the mediation policy.

106. The system of claim 97, wherein the policy module is configured to receive and store a mediation policy provided by several users who are members of a group and wherein the Internet service is configured to process and publish a mediation policy incorporating Internet content provided by users and Internet content generated by the Internet service for use by the group via the DNS server.

107. The system of claim 97, wherein the policy module is configured to receive and store a mediation policy provided by several users who are members of a group and wherein the Internet service is configured to aggregate and publish a mediation policy incorporating Internet content provided by users and Internet content generated by the Internet service for use by the group via the DNS server.

108. The system of claim 97, wherein the policy module is configured to receive and store a mediation policy provided by several users who are members of a group and wherein the Internet service is configured to suggest new Internet content and to publish a mediation policy incorporating Internet content provided by users and Internet content generated by the Internet service for use by the group via the DNS server.

109. The system of claim 97, wherein the policy module is configured to receive and store a mediation policy provided by several users who are members of a group and wherein the Internet service is configured to remove duplicate Internet content and to publish a mediation policy incorporating Internet content provided by users and Internet content generated by the Internet service for use by the group via the DNS server.

110. The system of claim 97, wherein at least one element of the policy module is resident on the DNS server.

111. The system of claim 97, wherein at least one element of the dynamic enforcement engine is resident on the DNS server.

112. The system of claim 97, wherein the mediation policy is configured to be updated automatically by the Internet service or to be updated manually via the initiating user account.

113. The system of claim 97, wherein the policy module is configured to receive and store a mediation policy provided by several users who are members of a group and wherein the Internet service is configured to alert the users about the existence related groups containing related Internet content.

114. The system of claim 97, wherein the initiating user account is configured to allow the initiating user to republish certain elements of an existing mediation policy via the DNS server.

115. The system of claim 97, wherein the initiating user account is configured to receive suggestions of Internet content from the users and wherein the Internet service is configured to receive ratings from users regarding the Internet content submitted by the users.

116. The system of claim 97, wherein the mediation policy is configured to be updated automatically by the Internet service or to be updated manually by the initiating user and wherein the initiating user account is configured to receive suggestions of Internet content from the users and wherein the Internet service is configured to receive ratings from users regarding the Internet content submitted by the users.

117. The system of claim 97, wherein the mediation policy is configured to be updated automatically by the Internet service or to be updated manually by the initiating user and wherein the Internet service is configured to create a group of users based on a rating of Internet content.

118. The system of claim 97, wherein the mediation policy is configured to be updated automatically by the Internet service or to be updated manually by the initiating user, wherein the policy module is configured to receive and store a mediation policy provided by several users who are members of a group, and wherein the policy module is configured to receive ratings of submitted Internet content from the several users within the group.

119. The system of claim 97, wherein the dynamic enforcement engine is configured to apply the mediation policy to direct the DNS server to mediate Internet access to the users in response to a user request from the user to resolve an Internet address.
